(19) United States
(12) Patent Application Publication
(10) Pub. No.: US 2011/0039583 A1
(43) Pub. Date: Feb. 17, 2011

(54) MUTING TIME MASKS TO SUPPRESS SERVING CELL INTERFERENCE FOR OBSERVED TIME DIFFERENCE OF ARRIVAL LOCATION

(75) Inventors: Colin FRANK, Park Ridge, IL (US); Sandeep KRISHNAMURTHY, Arlington Heights, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/542,374

(22) Filed: Aug. 17, 2009

(51) Int. Cl. H04W 24/00

(52) U.S. Cl. 455/456.5; 455/456.1

(57) ABSTRACT

A method, a user communication device, and a base station are disclosed. A network interface 260 may synchronize a serving positioning reference transmission 116 with the coordinated network 100. A transceiver 240 may send the serving positioning reference transmission 116 in a set of positioning subframes. A processor 210 may mute the serving positioning reference transmission 116 according to a muting pattern optimized to allow the user communication device 102 to receive a maximum number of neighbor positioning reference transmissions 118 for the set of positioning subframes.

### 1. FIELD OF THE INVENTION

The present invention relates to a method and system for locating a user communication device in a coordinated network. The present invention further relates to mitigating interference from the serving cell when determining the position of the user communication device.

### 2. INTRODUCTION

The Third Generation Partnership Project (3GPP) is developing a Long Term Evolution (LTE) standard using a physical layer based on globally applicable evolved universal terrestrial radio access (E-UTRA). In release-8 specification of LTE, an LTE base station, referred to as an enhanced Node-B (eNB), may use an array of four antennas to broadcast a signal to a piece of user equipment.

A user communication device, or user equipment (UE) device, may rely on a pilot or reference symbol (RS) sent from the transmitter for channel estimation, subsequent data demodulation, and link quality measurement for reporting. Further, the UE device may rely on a positioning reference symbol (PRS) to determine an observed time difference of arrival (OTDOA) of the PRS from one or more network base stations. The UE device may send the OTDOA to the network. The network may use that data to calculate the position of the UE device within the network by calculating the distance of the UE device from the network base stations of the network and triangulating the position of the UE device.

### SUMMARY OF THE INVENTION

A method, a user communication device, and a base station are disclosed. A network interface may synchronize a serving positioning reference transmission with the coordinated network. A transceiver may send the serving positioning reference transmission in a set of positioning subframes. A processor may mute the serving positioning reference transmission according to a timing mask optimized to allow the user communication device to receive a maximum number of neighbor positioning reference transmissions for the set of positioning subframes.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a coordinated communication system.

FIG. 2 illustrates a possible configuration of a computing system to act as a base transceiver station.

FIG. 3 illustrates, in a block diagram, one embodiment of a mobile system or electronic device to create a radio connection.

FIGS. 4a-b illustrate, in a block diagram, different embodiments of a resource block of a positioning subframe.

FIGS. 5a-b illustrate, in block diagrams, different embodiments of a muting pattern.

FIG. 6 illustrates, in a block diagram, one embodiment of a system information block.

FIG. 7 illustrates, in a flowchart, one embodiment of a method for determining the position of a user communication device using a serving base station.

FIG. 8 illustrates, in a flowchart, one embodiment of a method for measuring the observed time distance of arrival using the user communication device.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, a user communication device, and a network base station, and other embodiments that relate to the basic concepts of the invention. The user communication device may be any manner of computer, mobile device, or wireless communication device.

A method, a user communication device, and a base station are disclosed. A network interface may synchronize a serving positioning reference transmission with the coordinated network. A transceiver may send the serving positioning reference transmission in a set of positioning subframes. A processor may mute the serving positioning reference transmission according to a muting pattern optimized to allow the user communication device to receive a maximum number of neighbor positioning reference transmissions for the set of positioning subframes.

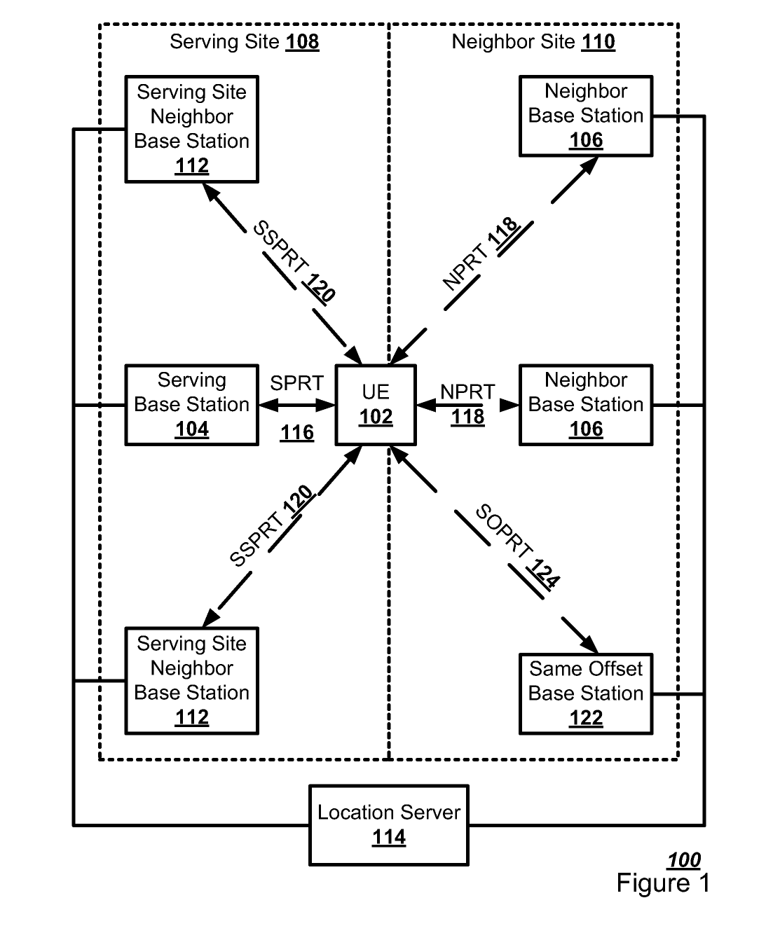

FIG. 1 illustrates one embodiment of a coordinated communication network 100. While a Long Term Evolution (LTE) carrier communication system 100, as defined by the Third Generation Partnership Project (3GPP®) is disclosed, other types of communication systems may use the present invention. Various communication devices may exchange data or information through the network 100. The network 100 may be an evolved universal terrestrial radio access (E-UTRA), or other type of telecommunication network.

A LTE user equipment (UE) device 102, or user communication device, may access the coordinated communication network 100 via any one of a number of LTE network base stations, or enhance Node Bs (eNB), that support the network. For one embodiment, the UE device 102 may be one of several types of handheld or mobile devices, such as, a mobile phone, a laptop, or a personal digital assistant (PDA). For one embodiment, the UE device 102 may be a WiFi® capable device, a WiMAX® capable device, or other wireless devices.

The primary network base station currently connecting the UE device 102 to the coordinated communications network may be referred to as a serving base station 104. Any other network base station that is proximate to the serving base station 104 may be referred to as a neighbor base station 106.

A cellular site may have multiple base stations. A cellular site having the serving base station 104 may be referred to as the serving site 108. A cellular site that does not have the serving base station 104 may be referred to as the neighbor site 110. A serving site 108 may also have one or more neighbor base stations 106 in addition to the serving network base station 108, referred to herein as a serving site neighbor base station 112.

The coordinated communication network 100 may use a location server 114 to triangulate the network location of the UE device 102 within the coordinated communication network 100. Alternatively, one of the base stations may act as a location server 114. Each base station may broadcast a positioning reference transmission to be received by the UE device 102. The location server 114 may use the positioning reference transmission to determine the location of the UE device 102 within the network 100. Alternately, the UE device 102 or the serving base station 104 may use the positioning reference transmission to determine the location. The positioning reference transmission may be a set of one or more positioning reference symbols (PRS) of various values arranged in a pattern unique to the base station sending the positioning reference transmission.

The positioning reference transmission from the serving base station 104 may be referred to as the serving positioning reference transmission (SPRT) 116. The positioning reference transmission from the neighbor base station 106 may be referred to as the neighbor positioning reference transmission (NPRT) 114. The positioning reference transmission from the serving site neighbor base station 112 may be referred to as a same site positioning reference transmission (SSPRT) 120. The UE device 102 may measure the observed time difference of arrival (OTDOA) for each NPRT 118, to determine the distance between the UE device 102 and each observed neighbor base station 106.

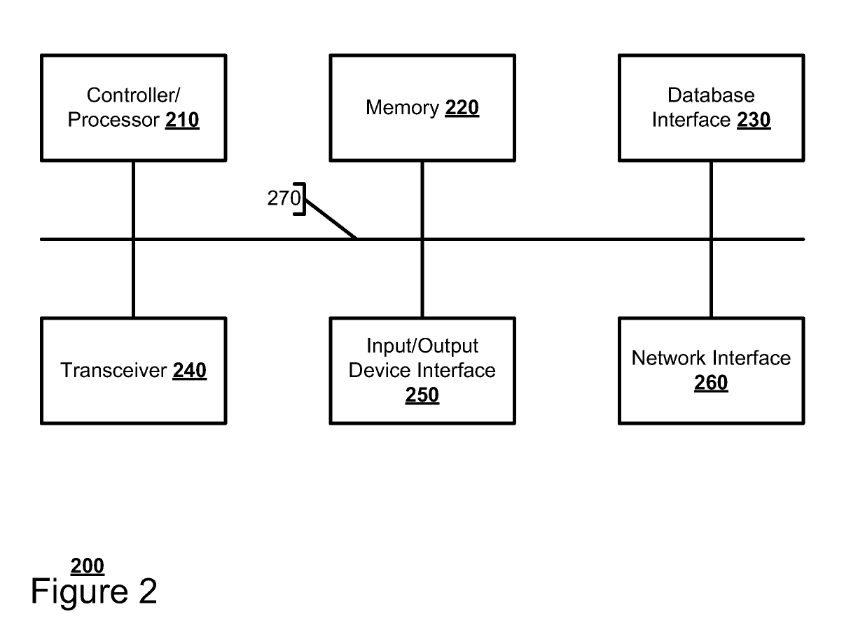

FIG. 2 illustrates a possible configuration of a computing system 200 to act as a network operator server 106 or a home network base station 110. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the method as described herein may be used to implement the system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc—read only memory (CD-ROM), digital video disc—read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain a subscriber information set for each UE device 102 that may access the network 100, as well as a physical cell identifier (PCID) for the base station.

The transceiver 240 may create a connection with the mobile device 104. The transceiver 240 may be incorporated into a base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The network interface 260 may connect the home network base station 110 to a mobility management entity of the network operator server 106. The components of the network server 200 may be connected via an electrical bus 270, for example, or linked wirelessly.

Client software and databases may be accessed by the controller/processor 210 from memory 220, and may include, for example, database applications, word processing applications, as well as components that embody the functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

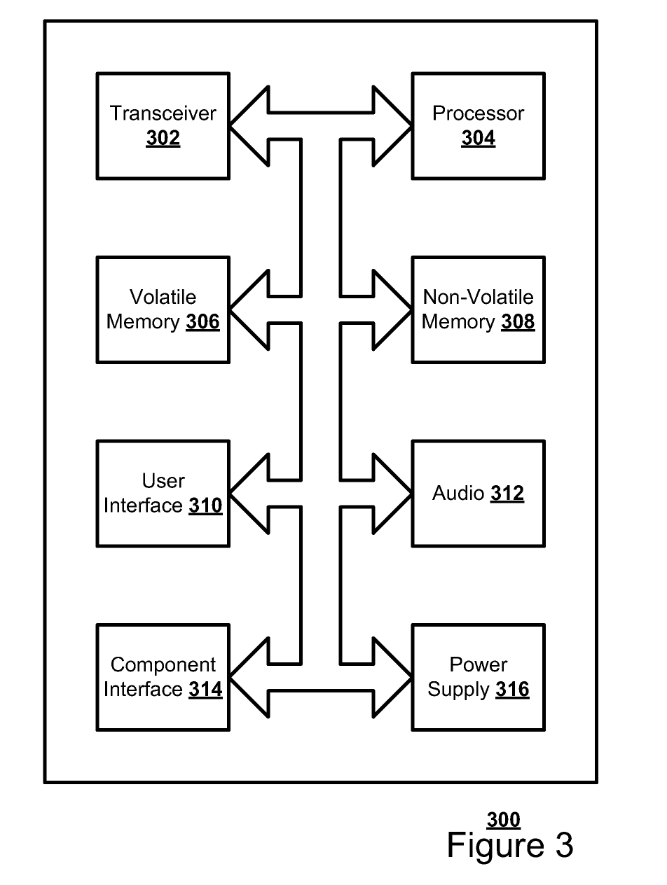

FIG. 3 illustrates one embodiment of a mobile device 300, capable of acting as a UE device 102 or user communication device. For some embodiments of the present invention, the mobile device 300 may also support one or more applications for performing various communications with a network. The mobile device 300 may be a handheld device, such as, a mobile phone, a laptop, or a personal digital assistant (PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 to act as data storage for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface. Finally, the mobile device 300 may include a power supply 316.

As each base station sends a different positioning reference transmission, the positioning reference symbols may become interlaced in the frequency domain. Each base station may apply one of a set of frequency offsets, for example a set of six frequency offsets, to better distinguish between the base stations. As a coordinated communication network 100 may have more base stations than frequency offsets, multiple base stations may be assigned the same offset. For example, if the network 100 has eighteen base stations and uses six frequency offsets, each frequency offset may be assigned to three base stations. Referring back to FIG. 1, a neighbor base station 106 that has the same frequency offset as the serving base station 104 may be referred to herein as a same offset base station 122. The positioning reference transmission of the same offset base station 122 may be referred to as a same offset positioning reference transmission (SOPRT) 124.

Depending on the bandwidth of the system, the positioning subframe may contain any number of resource blocks, such as six to one hundred resource blocks. The resource block may have, for example, twelve to fourteen symbols and twelve subcarriers. For a largest bandwidth of 20 MHz, the positioning subframe may have, for example, one hundred resource blocks, and thus 1200 subcarriers per subframe. The resource blocks may be stacked in frequency. Thus, for every symbol within the subframe, the subframe may have, for example, 1200 subcarriers.

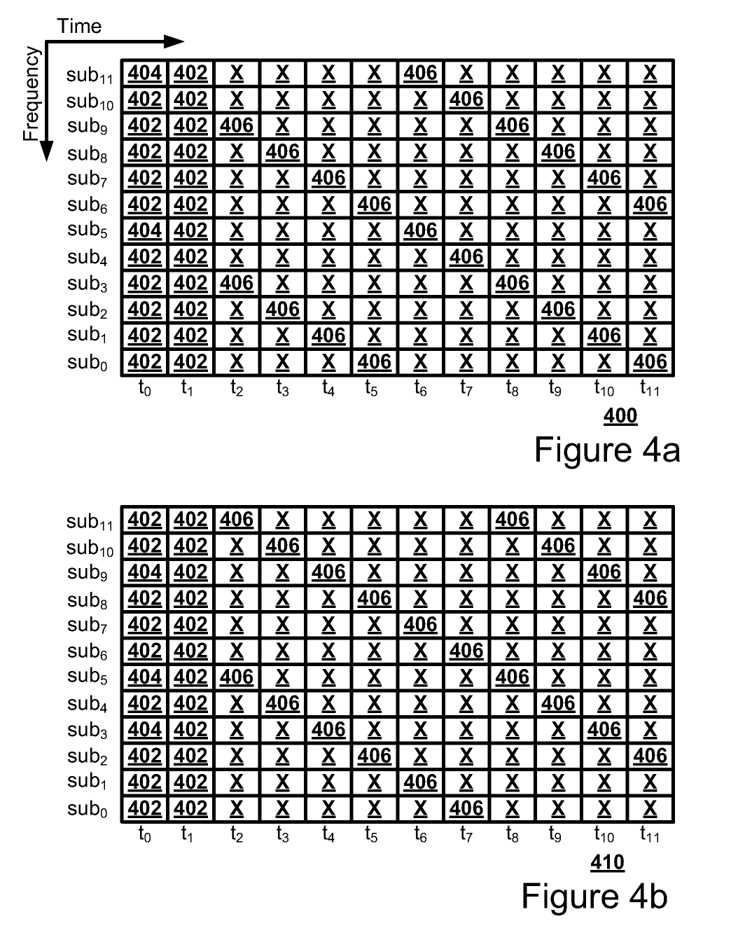

Different resource blocks may represent different base stations. FIG. 4a may illustrate, in a block diagram, one embodiment of a resource block 400 from a first base station, while FIG. 4b may illustrate, in a block diagram, one embodiment of a resource block 410 from a second base station. The positioning subframe may have both a time component and a frequency component. Each resource block 400 may begin with a set of control region symbols 402. The resource block 400 may have a common reference symbol representing an antenna port. One or more positioning reference symbols 406 may be encoded in the positioning subframe in a pattern. A UE device may use both the pattern and the values of the positioning reference symbols 406 to identify the originating base station.

In order to determine the position of the UE device 102 within the coordinated communication network 100, the UE device 102 may make time-difference-of-arrival measurements on the neighboring network base stations 106. The UE device 102 may use positioning subframes and positioning reference symbols to better “hear” neighbor base stations 106.

Even with the inclusion of positioning reference symbols 406, a UE device 102 near a serving base station 104 may have significant difficulty in measuring the OTDOA of a neighbor base station 106 for multiple reasons.

One reason may be the adaptive gain control or analog to digital converter limitations in the receiver. If the UE device is near the serving base station 104, the power of the serving base station 104 may far exceed that of the neighbor base station to be measured. As a result of these dynamic range limitations in the UE device 102, the UE device 102 may not be able to take measurements on a sufficient number of neighbor base stations 106 to enable an accurate position fix.

A second reason may be the misalignment of the positioning reference symbol (PRS) pattern. The PRS patterns may be orthogonal in the frequency domain. However, if two base stations are assigned orthogonal PRS patterns, the orthogonal nature of the corresponding positioning reference transmission signals received by the UE device 102 may depend on the positioning reference transmission signals being properly aligned as observed by the UE device 102. The positioning reference transmission signals may be considered properly aligned if the sum of the OTDOA and the channel delay spread do not exceed the cyclic prefix. Otherwise, the positioning reference transmission signals received by the UE device 102 may not be orthogonal even if the PRS patterns are. If a neighbor base station 106 is assigned a different pattern than the serving base station 104, the UE device 102 may make an OTDOA measurement on the neighbor base station 106 without interference from the serving base station 104, assuming no adaptive gain control or analog to digital converter limitations. However, if the sum of the OTDOA and the channel delay spread exceed the channel cyclic prefix, the OTDOA measurements may be contaminated with interference from the serving base station, which may be very strong when the UE device 102 is near the serving base station 104.

In a partially synchronous network, the positioning subframes from different base stations may be offset by as much as one-half a subframe or more, resulting in misalignment of the symbol boundaries. Thus, the PRS patterns which are orthogonal in the frequency domain when the positioning subframes are time aligned may no longer be orthogonal, regardless of the channel delay-spread or the OTDOA of the serving base station 104 and the neighbor base stations 106.

One solution to the above problems is to sometimes mute the serving base station 104 in order to enable the UE device 102 to take accurate OTDOA measurements on a sufficient number of neighbor base stations 106 when the UE device 102 is near the serving base station 104.

A set of diagonal PRS patterns may be defined for use in the positioning subframes. The patterns may be frequency offsets of a base diagonal pattern. In radio access network, consecutive subframes may be used as positioning subframes. Furthermore, the network may assign each of these consecutive subframes a random frequency offset f(nₚ,n_{rf}) as a function of the PCID in accordance with the following method

$$f ( {n}_{p} , {n}_{rf} ) = ( {\sum }_{i = 0}^{7} {2}^{i} c ( i + 8 {n}_{p} ) ) mod {n}_{rf} ,$$

where nₚ is the positioning subframe number and n_{rf} is the number of possible reuse patterns. The random sequence c(i) may be initialized in between every positioning occasion with cᵢₙᵢₜ=N^{ID}_{Cell}.

The base station may transmit the positioning reference transmission with zero power in certain positioning subframes, or mute certain positioning subframes. However, the UE device 102 may currently be unaware of whether or not a particular base station has muted its positioning reference transmission, leading to problems when the positioning reference transmission from a neighbour base station 106 is sufficiently weak to prevent a reliable determination of whether or not the positioning reference transmission were transmitted by a particular base station, and thus whether or not the OTDOA measurement for the base station is valid.

Given a number of N consecutive positioning subframes, which may or may not be consecutive subframes, the serving base station 104 may mute in such a way that all base stations transmit the positioning reference transmission an equal proportion of the time, and the UE device 102 may know when a PRS is present within a positioning subframe 104. Muting of the PRS within the positioning subframes may be implemented on a subframe basis, on a slot basis, or on blocks of consecutive symbols containing PRS. These blocks of consecutive symbols may or may not align with slot or subframe boundaries. While the implementation below discusses muting on a subframe basis, it may be modified in a straightforward manner to apply to muting either on a slot basis or on a block of consecutive symbols either within a single subframe, or alternatively, spanning the boundary across multiple subframes.

For example, if N consecutive subframes are used as positioning subframes, muting patterns of length N may be defined. The location server 116 may assign each base station a muting pattern of length N as a function of its PCID. The base station may use the assigned muting pattern to determine whether or not to transmit a PRS in a particular positioning subframe. If a given number K of these subframes are used to transmit PRS, then N-K subframes may be muted. The network 100 or serving base station 104 may select from comb(N,K)=N!/K!/(N−K)! ways to choose K subframes from N. Equivalently, this may result in comb(N,K) muting patterns or a subset of comb(N,K) being available for use.

The muting patterns with weight equal to K subframes may be chosen in one of three ways. First, all of the muting patterns may be allowed. The comb(N,K) patterns may be numbered from 1 to comb(N,K). Second, only a subset of the muting patterns may be allowed. The allowed muting patterns may be numbered from 1 to M, where M is less than or equal to comb(N,K). Third, the set of allowed patterns may be defined as circular shifts of a single muting pattern.

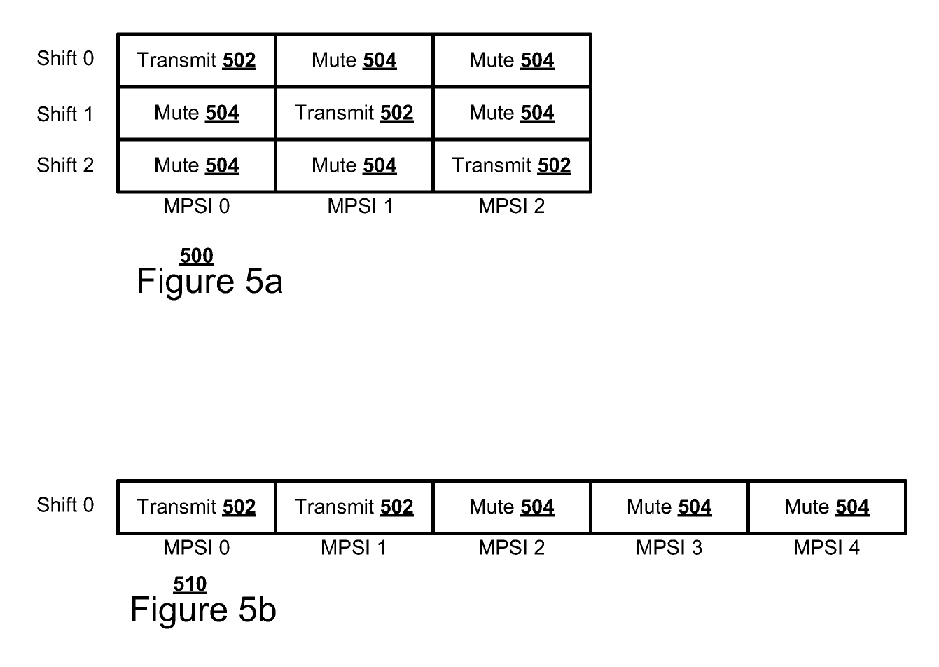

FIGS. 5a-b illustrate, in block diagrams, different examples of a muting pattern. In FIG. 5a, the length of the muting pattern 500 is N=3, and 3 shifts may be defined. The transmit period 502 may occur once for K=1. The mute period 504 may occur twice. In each shift, the transmit period may move to a different subframe. The positioning subframe to be transmitted or muted may be indicated by a subframe index of the muting pattern, or the muting pattern subframe index (MPSI). In FIG. 5b, the length of the muting pattern 510 is N=5, and 5 shifts may be defined. The transmit period 502 may occur twice for K=2. The mute period 504 may occur three times. The maximum number of patterns that may be defined is comb(N,K).

For N consecutive positioning subframe, M muting patterns of subframe weight K may be defined, where M is less than or equal to comb(N,K). The maximum number of muting groups may be used so that M is equal to comb(N,K), maximizing the number of PCID's for which OTDOA measurements may be taken without interference from the serving base station 104.

The above muting patterns may be applied as a time mask to the positioning reference transmission. Thus, the PRS pattern defined across N consecutive subframes may be multiplied by the muting time mask, where this PRS mask has value 1 where the PRS is not-muted, and have value 0 where the PRS is muted. The PRS mask may be applied to symbols within the positioning subframe that contain PRS. The PRS mask may be omitted from the portion of the positioning subframe that contains control channels or a common reference symbol. The muting pattern may be optimized to allow the UE device 102 to receive a maximum number of NPRTs 118 for the set of positioning subframes.

The muting pattern may be generated based upon a PCID for the serving base station 104. A muting mask may be assigned to each PCID, by using a random mapping or by mapping each of the PCID's to the muting pattern with index mod(PCID,M), where M is the number of muting patterns. Other, similar mappings may be defined which allocate each PCID a muting pattern time mask. For example, the same time mask may be allocated to different sectors of the same site, maximizing the number of sites that may be measured when the serving base station 104 is muted. In the case where different sectors are allocated consecutive PCIDs, allocating the muting pattern with index mod(floor(PCID/3),M) may be preferable to mod(PCID,M).

A further optimization may be made with respect to the subframe weight K. If OTDOA measurements are taken only when the serving base station 104 is muted, then the number of measurements which may be taken on PRS is given by (N−K)×(K/N)×[PCID Set Size], with multiple measurements allowed on the same PCID. For example, the PCID set size may be 504. If N is even, the above may be maximized when K=N/2, yielding 126*N.

For N=4 and K=2, the number of measurements may be 504, though 126 of these correspond to a second measurement of a PCID already measured, since 1/N of the PCID's (126) are in the same set as the serving base station 104 and may not be measured when the serving base station is muted.

For N=3, the number of measurements may be maximized when K=1 or K=2, yielding a maximum number of measurements. For example, if the PCID set size equals 504 the maximum number of measurements may be two-thirds of 504, or 336. In general, given N positioning subframes, measuring OTDOA for all of the PCID's when the serving site 108 is muted may be difficult, as some PCID's may always be in the same muting group as the serving site 108.

In order to maximize the opportunity to take measurements without interference from the serving base station 104 or serving site 108, the number of muting masks may be maximized for a given set of positioning subframes having a set size of N, where set size indicates the number of subframes in a set. If M denotes the number of time masks, or muting patterns, then a fraction 1/M of the PCID's may be assigned to each time mask. The UE device 102 may take measurements on a fraction (M−1)/M of the PCID's without interference from the serving base station 104. Each of the muting masks may be “on” for an equal number of subframes K, where K is less than N, where “on” denotes that positioning reference transmission is enabled within the positioning subframe. If the muting masks are defined to be the set of all masks for which K of the N subframes are on, then the number of such masks may be comb(N,K), maximized when K=┌N/2┐ or K=└N/2┘. Thus, the muting pattern may have the SPRT 116 transmitting for approximately half the set of positioning subframes and muted for approximately half the set of positioning subframes.

J(N,K) may denote the set of all numbers given by the set

$$J ( N , K ) = \{ {\sum }_{i = 1}^{K} {2}^{{j}_{i}} \text{:} 0 \leq {j}_{1} < {j}_{2} < … < {j}_{K} \leq N \} .$$

Jₒ(N,K) may denote the set of numbers J(N,K), ordered from smallest to largest. Each of the numbers in the set may be put into one-to-one correspondence with the set of all muting patterns of length N and weight K by using the binary representation of the numbers. The most significant bit of the N-bit binary representation may denote the mask value for the first of the N PRS subframes, and the least significant bit may denote the mask value for the last of the N PRS subframes.

Base stations at the same site may be assigned the same muting pattern, so as to minimize serving site interference. Thus, the serving base station 104 may mute the SPRT 116 while a serving site neighbor base station 112 mutes a SSPRT 120. Furthermore, base stations assigned to the same frequency offset of the positioning reference transmission may be assigned to different muting patterns in order to further minimize serving site interference. Thus, the serving base station 104 may mute the SPRT 116 while a same offset base station 122 sends a SOPRT 124. The network 100 may accomplish this by defining the frequency offset of the PRS pattern as a function of PCID, represented as v_{shift}=(PCID)mod n_{rf} where n_{rf} is the number of PRS patterns numbered from 1 to n_{rf}. Thus the location server 114 assigns a frequency offset to the SPRT 116 based on the PCID of the serving base station 104.

Further, the muting pattern may be generated based upon a PCID for the serving base station 104. The index j of the muting pattern into the set of M muting patterns may be defined as a function of PCID represented as

$$j = \{ \begin{matrix}mod ( ⌊ PCID / 3 ⌋ , M ) + 1 & for M odd \\ mod ( ⌊ PCID / 3 ⌋ + ⌊ PCID / 3 M ⌋ , M ) + 1 & for M even ,\end{matrix}$$

where the muting sets are indexed from 1 to M. Note that this definition may ensure equal division of the PCID's using the same PRS frequency shift between the M muting groups. As a result, the number of PCID's using both the same frequency shift and the same muting pattern as the serving base station 104 may minimized. Thus, only a small percentage of the PCID's may be assigned the same frequency shift and the same muting pattern as the serving base station 104. An alternative mapping of the PCID to a muting pattern j, which may be used in the event that n, is an integer multiple of 3, may be given by j=mod(└PCID/n_{rf}┘, M)+1. This mapping may ensure equal division of the PCID's using the same PRS frequency shift between the M muting groups.

In the event that consecutive positioning subframes are not consecutive subframes, the serving base station 104 may signal the subframe index of the muting pattern for the next positioning subframe to the UE device 102. The subframe index of the muting pattern may be common to all the base stations, regardless of the muting pattern used for a particular PCID. In general, the serving base station 104 may signal both the length and the subframe index of the muting pattern for the next positioning subframe. The subframe index of the muting pattern for the next positioning subframe may be included with the assumed L2 assistance data providing a neighbor list to the UE. As the length of the muting patterns may be semi-static, the serving base station 104 may include the set size with either the L2 assistance data or via a system information block (SIB).

Alternatively, a UE device 104 may reliably determine when the serving base station is transmitting a SPRT 116 and when not. This determination may allow the UE device 102 to determine the subframe index of the muting pattern for the next positioning subframe via the sequence of SPRT 116 and muting periods for the serving base station 104, obviating the need to signal the subframe index of the muting pattern for the next positioning subframe. As the length of the muting patterns may be semi-static, the server base station 104 may include the length of the muting pattern via a SIB in a system in which L2 assistance data may be omitted. Thus, with the muting pattern length provided via SIB, the subframe index of the muting pattern for the next positioning subframe may be detected blindly by the UE device 102 using the serving base station 104.

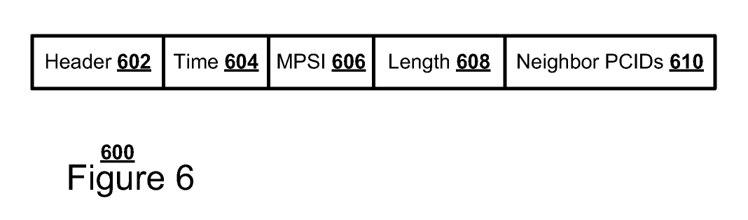

FIG. 6 illustrates, in a block diagram, one embodiment of a SIB 600. The serving base station 104 may send the SIB 600 to the UE device 102 so that the UE device 102 may properly interpret the positioning data. The SIB 600 may have a header 602 identifying the SIB 600. The SIB 600 may have a transmission time 604 for the set of positioning subframes. The SIB 600 may have the MPSI 606 for the next positioning subframe of the muting pattern. The SIB 600 may have the length 608 of the muting patterns. In some instances, the SIB 600 may contain a list of PCIDs of neighbor base stations 106 for which OTDOA may be taken.

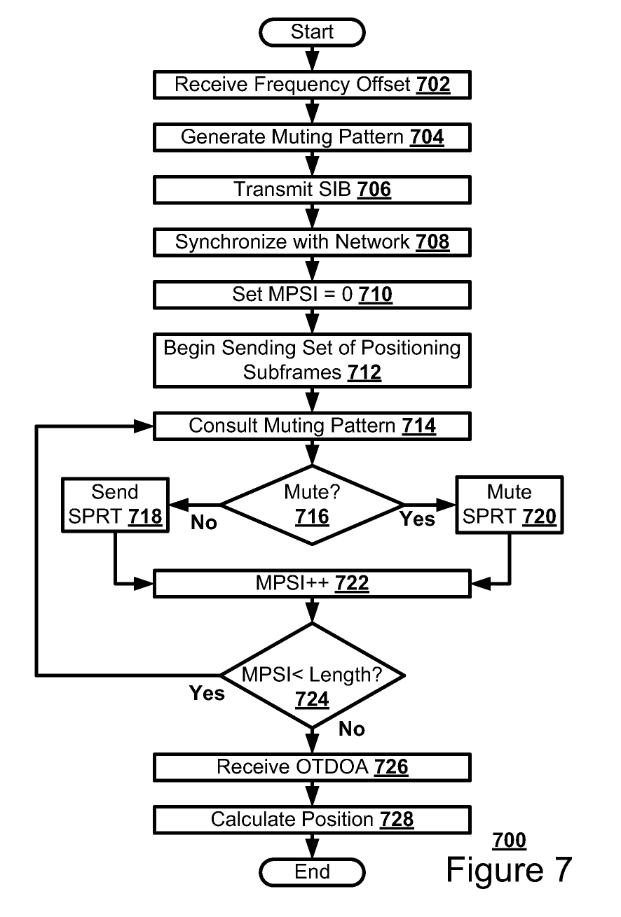

FIG. 7 illustrates, in a flowchart, one embodiment of a method 700 for determining the position of a user communication device using a serving base station 104. The serving base station 104 may receive a frequency offset assignment for the SPRT 116 based on the PCID (Block 702). The serving base station 104 may generate a muting pattern based upon the PCID (Block 704). The serving base station 104 may transmit the SIB 600 to the UE device 102 (Block 706). The serving base station 104 may synchronize the SPRT 116 with the coordinated network 100 (Block 708). The serving base station 104 may synchronize the SPRT 116 with the coordinated network based on a transmission from a global navigation satellite system (GNSS) source or by coordinating the SPRT 116 with at least one NPRT 118 of at least one neighbor base station 106. The serving base station 104 may use a MPSI to indicate the subframe index within the muting pattern of the next positioning subframe. The serving base station 104 may set the MPSI to 0 (Block 710). The serving base station 104 may then begin sending the set of positioning subframes (Block 712). The serving base station 104 may consult the muting pattern before sending a positioning subframe (Block 714). If the muting pattern does not indicate a muting period (Block 716), the serving base station 104 may send the SPRT 116 (Block 718). If the muting pattern indicates a muting period (Block 716), the serving base station 104 may mute the SPRT 116 (Block 720). The serving base station 104 may increment the MPSI (Block 722). If the MPSI is less than the length of the muting pattern for the set of positioning subframes, as measured in number of subframes (Block 724), the serving base station 104 may move to the next positioning subframe and consult the muting pattern (Block 714). Otherwise, the serving base station 104 may wait to receive the OTDOA for the NPRT 118 from the UE device 102 (Block 726). The serving base station 104 may calculate the network location for the UE device 102 based on the received OTDOA.

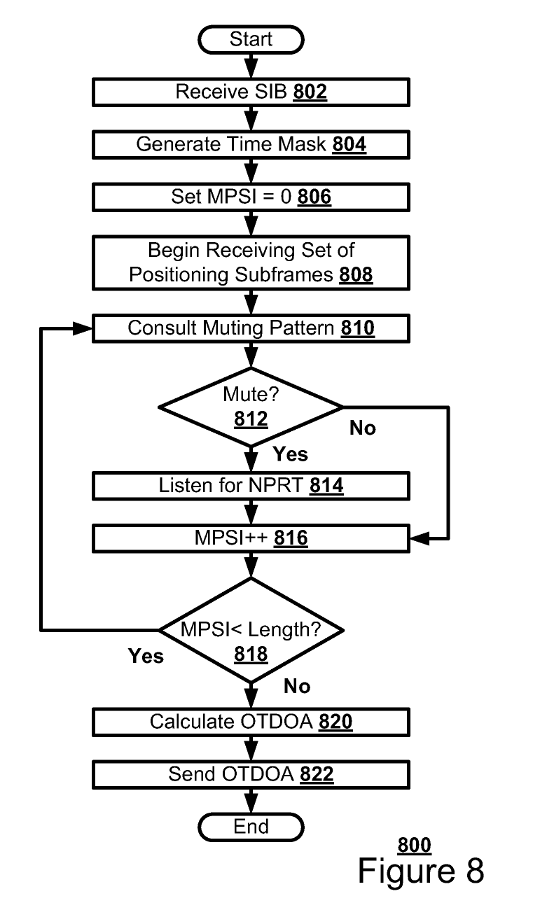

FIG. 8 illustrates, in a flowchart, one embodiment of a method 800 for measuring the OTDOA using the UE device 102. The UE device 102 may receive a SIB 600 from the serving base station 104 (Block 802). The UE device 102 may receive the MPSI for the next positioning subframe of the muting pattern from the base station, either via the SIB or via an L2 message using the radio link control. The UE device 102 may calculate a muting pattern for the serving base station 104 based upon the PCID (Block 804). Alternately, the UE device 102 may receive the muting pattern from the serving base station 104. The UE device 102 may use a MPSI to indicate the index within the muting pattern for the received positioning subframe. The UE device 102 may set the MPSI to 0 (Block 806). The UE device 102 may then begin receiving the set of positioning subframes (Block 808). The set of positioning frames may have the SPRT 116 synchronized with other positioning reference transmissions of the coordinated network, such as at least one NPRT 118 of at least one neighbor base station 106. The UE device 102 may consult the muting pattern as the positioning subframe is received (Block 810). The UE may determine the mask patterns for all of the neighbor base stations to determine which base stations are sending the positioning reference transmission in a particular positioning subframe. If the muting pattern indicates a muting period (Block 812), the UE device 102 may listen for the NPRT 118 (Block 814). Otherwise, the UE device 102 may increment the MPSI (Block 816). If the MPSI is less than the length of the muting pattern for the positioning subframes, as measured in number of subframes (Block 818), the UE device 102 may receive the next positioning subframe and consult the muting pattern (Block 810). Otherwise, the UE device 102 may calculate the OTDOA based upon any NPRTs 114 received during the muting periods (Block 820). The UE device 102 may then send the OTDOA to the serving base station 104 (Block 822).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for locating a user communication device within a coordinated network, comprising:
synchronizing a serving positioning reference transmission of a serving base station with the coordinated network;
sending the serving positioning reference transmission in a set of positioning subframes;
generating a muting pattern based upon a physical cell identifier for the serving base station; and
muting the serving positioning reference transmission according to the muting pattern.

2. The method of claim 1, further comprising:
optimizing the muting pattern to allow the user communication device to receive a maximum number of neighbor positioning reference transmissions for the set of positioning subframes.

3. The method of claim 1, wherein the muting pattern has the serving positioning reference transmission transmitting for approximately half the set of positioning subframes and muted for approximately half the set of positioning subframes.

4. The method of claim 1, further comprising:
assigning a frequency offset to the serving positioning reference transmission based on a physical cell identifier for the serving base station.

5. The method of claim 1, further comprising:
muting the serving positioning reference transmission while a serving site neighbor base station mutes a same site positioning reference transmission.

6. The method of claim 1, further comprising:
muting the serving positioning reference transmission while a same offset base station sends a same offset positioning reference transmission.

7. The method of claim 1, further comprising:
receiving from the user communication device an observed time difference of arrival for the at least one neighbor positioning reference transmission; and
calculating a network location for the user communication device based on the observed time difference of arrival.

8. The method of claim 1, further comprising:
transmitting to the user communication device at least one of a transmission time for the set of positioning subframes, a muting pattern length, a muting pattern subframe index, and at least one physical cell identifier for at least one neighbor base station.

9. A serving base station for a coordinated network that locates a user communication device, comprising:
a network interface that synchronizes a serving positioning reference transmission with the coordinated network;
a transceiver that sends the serving positioning reference transmission in a set of positioning subframes; and
a processor that mutes the serving positioning reference transmission according to a muting pattern optimized to allow the user communication device to receive a maximum number of neighbor positioning reference transmissions for the set of positioning subframes.

10. The base station of claim 9, wherein the muting pattern is based upon a physical cell identifier.

11. The base station of claim 9, wherein the muting pattern has the serving positioning reference transmission transmitting for approximately half the set of positioning subframes and muted for approximately half the set of positioning subframes.

12. The base station of claim 9, wherein the network interface receives a frequency offset assignment for the serving positioning reference transmission based on physical cell identifier.

13. The base station of claim 9, wherein the processor mutes the serving positioning reference transmission while a serving site neighbor base station mutes a same site positioning reference transmission.

14. The base station of claim 9, wherein the processor mutes the serving positioning reference transmission while a same offset base station sends a same offset positioning reference transmission.

15. The base station of claim 9, wherein the processor calculates a network location for the user communication device based on an observed time difference of arrival for the at least one neighbor positioning reference transmission received from the user communication device.

16. A user communication device for interacting with a coordinated network, comprising:
a transceiver that receives a set of positioning subframes having a serving positioning reference transmission of a serving base station synchronized with at least one neighbor positioning reference transmission of at least one neighbor base station, with the serving positioning reference transmission muted according to a muting pattern optimized to allow the user communication device to receive a maximum number of neighbor positioning reference transmissions for the set of positioning subframes; and
a processor that calculates an observed time difference of arrival for the at least one neighbor positioning reference transmission.

17. The user communication device of claim 16, wherein the processor calculates the muting pattern based upon a physical cell identifier for the serving base station.

18. The user communication device of claim 16, wherein the muting pattern has the serving positioning reference transmission transmitting for approximately half the set of positioning subframes and muted for approximately half the set of positioning subframes.

19. The user communication device of claim 16, wherein the transceiver receives at least one physical cell identifier for at least one neighbor base station from the serving base station.

20. The user communication device of claim 16, wherein the processor calculates the observed time difference of arrival based upon the at least one neighbor positioning reference transmission received while the serving positioning reference transmission is muted.
